(19) United States
(12) Patent Application Publication
(10) Pub. No.: US 2023/0103024 A1
(43) Pub. Date: Mar. 30, 2023

(54) TOROIDAL INDUCTORS

(71) Applicant: Hamilton Sundstrand Corporation, Charlotte, NC (US)

(72) Inventor: Andrew J. Benn, Birmingham (GB)

(21) Appl. No.: 17/953,469

(22) Filed: Sep. 27, 2022

(30) Foreign Application Priority Data
Sep. 30, 2021 (EP) 21200266.1

(51) Int. Cl. H01F 17/06; H01F 41/08

(52) U.S. Cl. CPC H01F 17/062; H01F 41/08; H01F 2017/0093

(57) ABSTRACT

A toroidal inductor includes a toroidal core and at least one coil is disclosed. Each coil comprises at least one first winding portion, and at least one second winding portion. At least one first winding portion comprises at least one alpha electrical pathway which extends between a first alpha pathway end to a second alpha pathway end. At least one second winding portion comprises at least one beta electrical pathway which extends between a first beta pathway end to a second beta pathway end (30B). The first and second winding portions are electrically connected to form at least one coil wound around the toroidal core. Each coil is comprised of a plurality of pathway units, and each pathway unit comprises an alpha electrical pathway connected to a beta electrical pathway.

### CROSS-REFERENCE TO RELATED APPLICATIONS

This application claims priority to European Patent Application No. 21200266.1 filed Sep. 30, 2021, the entire contents of which is incorporated herein by reference.

### FIELD

This disclosure relates to toroidal inductors and, in particular to toroidal common mode and differential mode chokes.

### BACKGROUND

Toroidal inductors are passive electronic components which include a toroidal shaped magnetic core around which a coil is wound. The core is formed from a ferromagnetic material such as laminated iron, iron powder, or ferrite. Typically each coil is formed from an electrically conductive wire is wound around the core for part of the length of the core.

Common mode and differential mode chokes have two or more coils wound on a single core. They are useful for suppression of electromagnetic interference or noise (EMI) and radio frequency interference or noise (RFI) in power supply and data lines and for prevention of malfunctioning of electronics devices.

In the context of toroidal inductors and the nomenclature associated with toroidal inductors, the core is a ring of ferromagnetic material that has an outer surface that is a surface of revolution around an axis of revolution. The core has a length which is circular and centred on a centre point on the axis of revolution. Reference to the or a length of the core is to be understood to be reference to the whole or a part of the radially outer circumference of the core around the axis of revolution unless otherwise stated. The or a length of the core may be measured from an arbitrary position on the core. Typically the arbitrary position is chosen to be the position of the starting point for a coil/winding of the wire around the core. Reference to winding the wire around the core is, unless stated otherwise, reference to winding the wire so that each wind of the wire passes around a section of the core and passes at least once through the hole in the core through which the axis of rotation extends and around which the core extends.

The wire that forms the or each coil of a toroidal inductor may be an insulated wire, typically an enamelled wire such as an enamelled copper wire. The wire is typically wound around the core so that the wire is in contact with the surface of the core or close to that surface, sometimes the wires will overlie each other.

### SUMMARY

According to a first aspect of the present disclosure there is provided a toroidal inductor comprising a toroidal core and at least one coil. Each coil includes at least one first winding portion, and at least one second winding portion. At least one first winding portion comprises at least one alpha electrical pathway which extends between a first alpha pathway end to a second alpha pathway end. At least one second winding portion comprises at least one beta electrical pathway which extends between a first beta pathway end to a second beta pathway end. The first and second winding portions are electrically connected to form at least one coil wound around the toroidal core, and each coil is comprised of a plurality of pathway units. Each pathway unit comprises an alpha electrical pathway connected to a beta electrical pathway, in which the second alpha pathway end is connected to the first beta pathway end, and the second beta pathway end is connected to the first alpha pathway end of the next pathway unit along the coil.

Currently known toroidal inductors comprise a toroidal core and one or more coils. Each coil comprises a wire which is wrapped around the toroidal core a plurality of times. To manufacture such inductors, and in particular the or each coil, requires specialist winding machines and the skills to set up and operate such winding machines. This has the result that toroidal inductors are typically manufactured by companies that have such machines.

When a user of toroidal inductors requires a toroidal inductor of a standard configuration, for example in terms of size, number of coils, the number of times each wire is wound around the core in each coil, the spacing of the coils from each other, and the spacing of the wire along the length of the core within each coil, then they can readily obtain such an inductor from a manufacturer or stockist of such inductors. If, however, non-standard inductors are required, then it is likely that such inductors will need to be custom made for the party that wants them. Such custom manufacture is expensive and it can take a considerable time. The expense is particularly problematic for users of such inductors if only a small number of inductors are required.

An advantage of the first aspect of the present disclosure is that because each coil is comprised of one or more first and second winding portions which are joined so as to extend around the core, there is no need for the specialist winding machines to manufacture the coils and toroidal inductors of the present disclosure. The elements of the toroidal inductor can, instead, be formed using more standard apparatus and then constructed into a toroidal inductor, optionally by hand. For toroidal inductors where only a small or low number of inductors is required manufacture by hand can offer greater efficiencies than seeking to mechanise or automate construction.

A further advantage of the present disclosure is that one or both of the first and second winding portions can be easily replaced or modified so that trialling new designs of coil and or toroidal inductor is possible at significantly lower cost than would be experienced if a winding machine had to be set up for each trial design.

In an embodiment of the above embodiment, at least one beta electrical pathway comprises a length of an electrically conductive wire.

In an embodiment of any of the above embodiments each beta electrical pathway comprises a length of an electrically conductive wire.

In an embodiment of any of the above embodiments at least one second winding portion is a beta electrical pathway.

In an embodiment of any of the above embodiments each second winding portion is a beta electrical pathway.

In an embodiment of any of the above embodiments the electrically conductive wire is one of an insulated wire, an insulated copper wire, an enamelled wire, or an enamelled copper wire. Use of such wire prevents the beta electrical pathways unintentionally coming into electrical contact with each other, that is other than via an alpha electrical pathway. Enamelled wire is also known as magnet wire.

In an embodiment of any of the above embodiments each second winding portion is configured to extend more than halfway around the toroidal core.

In an embodiment of any of the above embodiments each second winding portion is configured to be in contact with or close to the part of the surface of the toroidal core about which the second winding portion extends. It is often the case that the toroidal core has a cross-section on a radius from the axis of rotation for the toroid that is circular or rectangular. The second winding portions of this embodiment have, when used with such toroidal cores, a configuration that closely matches the surface configuration of those cores. For example, where the core has a circular cross-section the second winding portions include a portion that describes an arc of about the same radius as the cross section of the core. In some embodiments second winding portions may be elastically or plastically deformable and the arc about which the second winding portion extends may be more than 180 degrees. In such embodiments the second winding portion may be deformed to place it around part of the core and then allowed or caused to return to its original configuration around the core.

Where the core has a rectangular cross-section the second winding portion may extend around three sides of the rectangle that is the cross-section of the core.

In an embodiment of any of the above embodiments at least one first winding portion comprises a body element. A body element may support one or more alpha electrical pathways. This is advantageous because the supporting of the alpha electrical pathways will, when there is more than one alpha electrical pathway, ensure that the alpha electrical pathways have the orientation and spacing relative to each other that is desired by the designer of the toroidal inductor. A further advantage is that the supporting of the alpha electrical pathways in a desired spatial relationship causes the beta electrical pathways (each of which extends between the first alpha end of one alpha electrical pathway and the second alpha end of another alpha electrical pathway) to adopt a desired spatial relationship relative to each other.

In an embodiment of any of the above embodiments when the toroidal inductor includes more than one coil the first winding portion is common to at least two of or each of the coils. This has the advantage that there is a single or low number of body elements and that the alpha electrical pathways for two or more or each coil are supported on the same body element.

In an embodiment of any of the above embodiments, a single body element is common to each coil, the body element has a first surface configured to support the toroidal core at a support position in which the axis of revolution of the toroidal core is approximately normal to the first surface. Each alpha electrical pathway is configured and arranged relative to the support position on the body element so that when the toroidal core is supported at the support position one end of each alpha electrical pathway can be accessed through the hole in the toroidal core, and the other end of each alpha electrical pathway can be accessed not through the hole in the toroidal core. This arrangement has the advantage that each second winding portion can be relatively easily connected to the first alpha end of one alpha electrical pathway and the second alpha end of another alpha electrical pathway.

In an embodiment of any of the above embodiments the body element comprises one of a through-hole circuit board, a surface mount circuit board, or an insulated metal substrate (IMS) surface mount circuit board (also known as a metal core circuit board). The use of circuit boards is advantageous because they are readily available, easy to work with, and adapted to be used in connection with electrically conductive components.

It is known that toroidal inductors produce heat whilst they are functioning. Thermal management of the inductor and the surrounding environment is, as a result, often desirable. Use of IMS circuit boards in association with toroidal inductors is advantageous because of the high level of thermal transfer and as a result thermal management that an IMS circuit board allows.

In an embodiment of any of the above embodiments at least one alpha electrical pathway comprises a conductive track on, or integral with, the printed circuit board. In some embodiments all of the alpha electrical pathways are conductive tracks on a single circuit board.

In an embodiment of any of the above embodiments the body element may support markings to assist the maker of the inductor in making the inductor. For example, the markings may show the support position for the toroidal core, or may assist the maker connect the desired alpha and beta electrical pathways in the desired order. This is advantageous because it avoids the possible connection of one or more beta electrical pathways from one coil to alpha electrical pathways of a different coil.

In an embodiment of any of the above embodiments at least one alpha electrical pathway comprises an electrically conductive element supported on the body element. That electrically conductive element may be a bar or wire of electrically conductive material.

According to a second aspect of the present disclosure there is provided a method for manufacturing a toroidal inductor according to the first aspect of the present disclosure. That method includes the steps of: (a) providing a toroidal core; (b) providing at least one first winding portion which comprises at least one alpha electrical pathway which extends between a first alpha pathway end to a second alpha pathway end; (c) providing at least one second winding portion which comprises at least one beta electrical pathway which extends between a first beta pathway end to a second beta pathway end; and (d) connecting the at least one first winding portion and the at least one second winding portion around the toroidal core.

The first winding portions and second winding portions are connected to form one or more coils wound around the toroidal core, each coil is comprised of a plurality of pathway units, each pathway unit comprises an alpha electrical pathway connected to a beta electrical pathway, the second alpha pathway end is connected to the first beta pathway end, and the second beta pathway end is connected to the first alpha pathway end of the next pathway unit along the coil. The beginning and end of each coil are electrically connected to power or data line in which the electrical noise needs to be reduced.

In an embodiment of any of the above embodiments the method of connection between at least one alpha pathway end and beta pathway end comprises one of a soldering process, a brazing process, a physical clamping of an alpha pathway end to a beta pathway end, or a physical clamping of an alpha pathway end and a beta pathway end to an electrically conductive clamping element that extends between the alpha and beta ends. Each of these methods forms an electrically conductive connection between the alpha pathway end and beta pathway end. The appropriate method may be chosen on the basis of available space around the toroidal core, the ease of making the connection, and anticipated operational temperatures. Other criteria may also affect the choice of connection method. If space around the toroidal core is limited, surface mount soldering can occur over an area no bigger than the contact area between an alpha pathway end and a beta pathway end.

According to a third aspect of the present disclosure there is provided a kit of parts suitable for the construction of a toroidal inductor including a toroidal core, at least one first winding portion, and at least one second winding portion. At least one first winding portion comprises at least one alpha electrical pathway which extends between a first alpha pathway end to a second alpha pathway end, and at least one second winding portion comprises at least one beta electrical pathway which extends between a first beta pathway end to a second beta pathway end. The first and second winding portions are adapted to be electrically connected to form at least one coil wound around the toroidal core, and each coil is comprised of a plurality of pathway units. Each pathway unit comprises an alpha electrical pathway connected to a beta electrical pathway, the second alpha pathway end is connected to the first beta pathway end, and the second beta pathway end is connected to the first alpha pathway end of the next pathway unit along the coil. In some embodiments the kit may contain two or more different toroidal cores, first winding portions and/or second winding portions. This will allow a user of such a kit to construct different toroidal inductors using the kit.

In an embodiment of any of the above embodiments each first winding portion of the kit comprises at least one body element, and at least one body element comprises one of a through-hole printed circuit board, a surface mount printed circuit board, or an insulated metal substrate surface mount printed circuit board.

### BRIEF DESCRIPTION OF FIGURES

The present invention will be further described and explained by way of example with reference to the accompanying drawings in which:

FIG. 1 shows a representative known toroidal common mode choke in plan view;

FIG. 2 shows the choke of FIG. 1 in side view;

FIG. 3 shows a perspective view of an embodiment of a common mode choke according to the present disclosure;

FIG. 4 shows an embodiment of a second winding portion of FIG. 3;

FIG. 5 shows a plan view of an embodiment of the body element of the choke of FIG. 3;

FIG. 6 shows a schematic plan view of the choke of FIG. 3;

FIG. 7 shows a first embodiment of a sectional view along the line AA of FIG. 6;

FIG. 8 shows a second embodiment of a sectional view along the line AA of FIG. 6; and

FIG. 9 shows a third embodiment of a sectional view along the line AA of FIG. 6.

### DETAILED DESCRIPTION

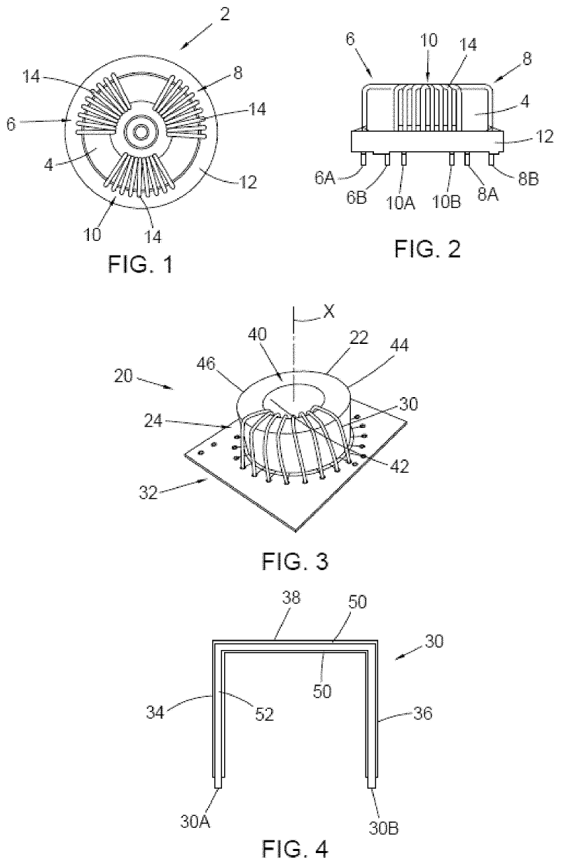

With reference to FIGS. 1 and 2, a known three phase toroidal common mode choke 2 is shown. The choke 2 includes a toroidal core 4, first, second and third coils 6, 8, 10 and a support 12. Each of the coils 6, 8, 10 is formed from an insulated wire 14 wound around the core 4 a plurality of times. The wire 14 that forms each coil 6, 8, 10 has a first and second end 6A, 6B, 8A, 8B, 10A, 10B which are connected to the power or data lines (not shown) from which electronic noise is to be removed.

With reference to FIG. 3, a partially assembled three phase toroidal common mode choke 20 is shown. The choke 20 includes a toroidal core 22, a first coil 24, and a body element 32. Second and third coils 26, 28 are not shown in FIG. 3 but will be spaced along the remainder of the length of the core 22 when placed in position. The first coil 24 includes a plurality of second winding portions in the form of hoops of insulated wire 30 (only one of which is labelled for clarity). The toroidal core 22 defines a hole 40 through which the axis of rotational X of the toroidal core 22 extends. The toroidal core 22 has a rectangular cross-section with the radially inner and radially outer faces 42, 44 of the toroidal core 22 extending substantially parallel to the axis of rotational X. Axially facing faces 46, 48 of the toroidal core 22 face in the same direction as axis of rotational X. Only axial face 46 may be seen in FIG. 3.

With reference to FIG. 4, each hoop 30 is formed from first and second legs 34, 36 and a middle portion 38. The first and second legs 34, 36 and middle portion 38 are disposed relative to each other so that the first and second legs 34, 36 and middle portion 38 can sit closely on the surface of the toroidal core 22 with the first leg 34 extending through the hole 40 and close to radially inner face 42 of the toroidal core 22, and second leg 36 extends along and close to radially outer face 44 of the toroidal core 22. Middle portion 38 extends across the axial face 46 of the toroidal core 22.

The hoop 30 is formed from a copper wire 52 which has, along almost all of its length, an insulating cover 50. The free ends 30A 30B of the hoop 30 have the insulating cover 50 removed as shown in FIG. 4.

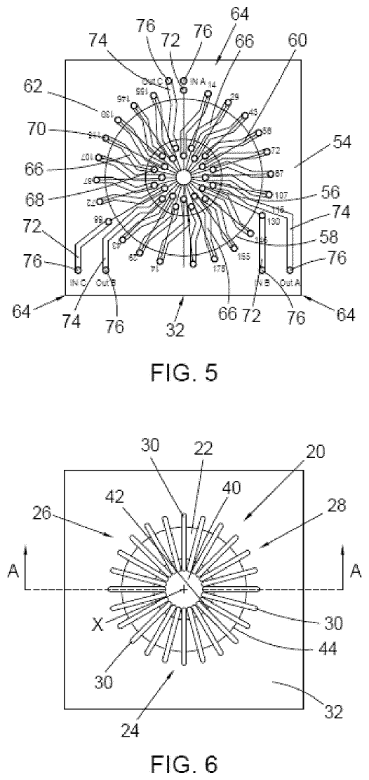

With reference to FIG. 5, the body element 32 is a circuit board 54. The circuit board 32 illustrated in FIG. 5 is an insulated metal substrate (IMS) surface mount circuit board. The circuit board 54 includes a plurality of alpha electrical pathways 66 (only three of which are labelled for clarity). Each alpha electrical pathway 66 is a conductive strip on the surface of the circuit board 54 or integral with the circuit board 54. At a first alpha end of each alpha electrical pathway 66 is a contact pad 68 (only one labelled for clarity). At the second alpha end of each alpha electrical pathway 66 is a contact pad 70 (only one labelled for clarity).

At either intended end of a coil 24, 26, 28 the circuit board 54 includes a conductive strip 72, 74 which acts as an input and an output to one of the coils 24, 26, 28. At the radially outer end of each of the contact strips 72, 74 is a contact pad 76

Each of the contact pads 68 and 70 are adapted to have an end 30A, 30B respectively of a hoop 30 soldered to it using a standard surface mount soldering process, for example the reflow process. Each of contact pads 76 are adapted to have a power line or data line (not shown) soldered to the pad. Again the soldering is performed using a standard surface mounting process.

The circuit board 54 carries on it a number of markings to assist a person constructing the choke 20 to make it correctly. A first set of markings 56, 58 show the intended location of the radially inner and outer faces 42, 44 of the core 22. These markings ensure that the constructor places the core 22 in the correct position before commencing joining the alpha electrical pathways 66 and the hoops 30. The correct position is one in which the contact pads 68/first alpha ends of the alpha electrical pathway 66 are all accessible through the hole 40 in the core 22, and the contact pads 70/second alpha ends of the alpha electrical pathway 66 are all accessible without passing through the hole 40 in the core 22.

A second set of markings 60 (only one of which is labelled for clarity) on the circuit board 54 show a constructor which first alpha end/contact pad 68 is to be joined to which second alpha end/contact pad 70 by each beta electrical pathway/hoop 30. This ensures that the constructor creates a continuous coil 24, 26, or 28 around the core 22.

A third set of markings 62 (only one of which is labelled for clarity) on the circuit board 54 provides the constructor with a reference system to allow individual identification of each hoop 30. In the illustrated example the reference system is the angle (in degrees and up to 180) from the start of the coil 28, and a position diametrically opposite the start of the coil 28. Other unillustrated reference systems can be employed.

A fourth set of markings 64 on the circuit board 54 relate to the beginning and ends of the coils 24, 26, and 28 (when the choke 20 is constructed) and the input and output connections 72, 74 and their associated contact pads 76. These marking assist in ensuring that the choke 20 (when fully constructed) is correctly connected into the electrical system of which it is a part.

In other, unillustrated examples of a body element 32 the conductive tracks 66, 72 and 74 are replaced by conductive elements that have the same relative positions and alignments as those conductive tracks shown in FIG. 5.

With reference to FIG. 6, once the core 22 is correctly positioned and each second winding portion/hoop 30 is electrically connected to each part of the first winding portion/conductive pads 68, 70 a choke 20 is formed as shown.

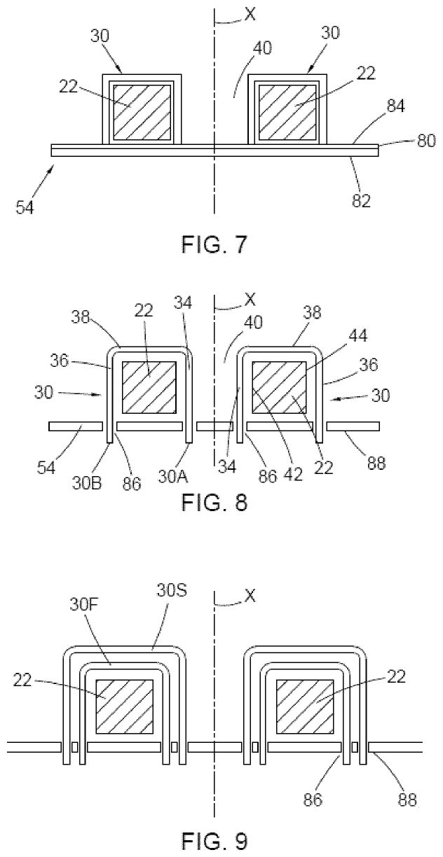

With reference to FIG. 7, this Figure shows a cross section along the line AA when the circuit board 54 is an insulated metal substrate (IMS) surface mount circuit board. The circuit board includes a plurality of conductive tacks 66, 72, 74 (not shown) which are located on the upper (as viewed in FIG. 7) face 84 of the circuit board 54. The upper face of the circuit board 54 is formed by an insulation layer 80 formed from a polymer or ceramic material. The insulation layer 80 is supported on an aluminium carrier layer 82. The aluminium carrier layer 82 is an efficient heat conductor and dissipates heat generated by the operation of the choke 20.

With reference to FIG. 8, this Figure shows a cross section along the line AA when the circuit board 54 is a through hole circuit board. Each end 30A, 30B of each hoop 30 passes through a hole 86 (only two labelled for clarity) in the circuit board 54. The circuit board includes a plurality of conductive tacks 66, 72, 74 (not shown) which are located on the lower (as viewed in FIG. 8) face 88 of the circuit board 54. The ends 30A, 30B of the hoop 30 are soldered to the conductive tracks 66 using standard soldering techniques.

With reference to FIG. 9, this Figure again shows a cross section along the line AA when the circuit board 54 is a through hole circuit board. In FIG. 9, however, it can be seen that the design of the coils 24, 26, 28 is such that each of the coils 24, 26, 28 includes a first set of hoops 30F which extend around three sides of the core 22 as in previously discussed examples. The coils 24, 26, 28 also include a second set of hoops 30S which extend around the outside face (the face remote from the core 22) of the hoops 30F. The hoops 30F and 30S are again connected via conductive tracks 66 (not shown). A persons skilled in the art of the present disclosure will readily understand how to layout an appropriate arrangement of such conductive tracks 66.

The above description is meant to be exemplary only, and one skilled in the art will recognize that changes may be made to the embodiments described without departing from the scope of the present disclosure. Still other modifications which fall within the scope of the present disclosure will be apparent to those skilled in the art, in light of a review of this disclosure.

Various aspects of the toroidal inductors disclosed in the various embodiments may be used alone, in combination, or in a variety of arrangements not specifically discussed in the embodiments described above. This disclosure is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be obvious to those skilled in the art that changes and modifications may be made without departing from this invention in its broader aspects. The scope of the following claims should not be limited by the embodiments set forth in the examples, but should be given the broadest reasonable interpretation consistent with the description as a whole.

1. A toroidal inductor comprising:
a toroidal core; and
at least one coil, in which each coil comprises at least one first winding portion, and at least one second winding portion, in which:
at least one first winding portion comprises at least one alpha electrical pathway which extends between a first alpha pathway end to a second alpha pathway end,
at least one second winding portion comprises at least one beta electrical pathway which extends between a first beta pathway end to a second beta pathway end,
the first and second winding portions are electrically connected to form at least one coil wound around the toroidal core,
each coil is comprised of a plurality of pathway units, and
each pathway unit comprises an alpha electrical pathway connected to a beta electrical pathway, the second alpha pathway end is connected to the first beta pathway end, and the second beta pathway end is connected to the first alpha pathway end of the next pathway unit along the coil.

2. A toroidal inductor according to claim 1, wherein at least one beta electrical pathway comprises a length of an electrically conductive wire.

3. A toroidal inductor according to claim 2, wherein each beta electrical pathway comprises a length of an electrically conductive wire.

4. A toroidal inductor according to claim 2, wherein the electrically conductive wire is one of an insulated wire, an insulated copper wire or an enamelled copper wire.

5. A toroidal inductor according to claim 1, wherein each second winding portion is configured to extend more than halfway around the toroidal core.

6. A toroidal inductor according to claim 5, wherein each second winding portion is configured to be in contact with or close to the part of the surface of the toroidal core about which the second winding portion extends.

7. A toroidal inductor according to claim 1, wherein at least one first winding portion comprises a body element.

8. A toroidal inductor according to claim 7, wherein:
the body element has a first surface configured to support the toroidal core at a support position in which the axis of revolution of the toroidal core is approximately normal to the first surface;
each alpha electrical pathway is configured and arranged relative to the support position on the body element so that when the toroidal core is supported at the support position one end of each alpha electrical pathway can be accessed through a hole in the toroidal core, and
the other end of each alpha electrical pathway can be accessed not through the hole in the toroidal core.

9. A toroidal inductor according to claim 7, wherein the body element comprises one of a through-hole circuit board, a surface mount circuit board, or an insulated metal substrate surface mount circuit board.

10. A toroidal inductor according to claim 9, wherein at least one alpha electrical pathway comprises a conductive track on the circuit board.

11. A toroidal inductor according to claim 7, wherein in which at least one alpha electrical pathway comprises an electrically conductive element supported on the body element.

12. A method for manufacturing a toroidal inductor according to claim 1, the method comprising:
(a) providing a toroidal core;
(b) providing at least one first winding portion which comprises at least one alpha electrical pathway which extends between a first alpha pathway end to a second alpha pathway end; and
(c) providing at least one second winding portion which comprises at least one beta electrical pathway which extends between a first beta pathway end to a second beta pathway end, wherein:
the first winding portions and a second winding portions are connected to form at least one coil wound around the toroidal core,
each coil is comprised of a plurality of pathway units,
each pathway unit comprises an alpha electrical pathway connected to a beta electrical pathway, the second alpha pathway end is connected to the first beta pathway end, and the second beta pathway end is connected to the first alpha pathway end of the next pathway unit along the coil.

13. A method according to claim 11, wherein the connection between at least one alpha pathway end and beta pathway end comprises one of a soldering process, a brazing process, a physical clamping of an alpha pathway end to a beta pathway end, or a physical clamping of an alpha pathway end and a beta pathway end to an electrically conductive clamping element.

14. A kit of parts suitable for the construction of a toroidal inductor comprising
a toroidal core and at least one coil, in which each coil comprises at least one first winding portion, and at least one second winding portion;
at least one first winding portion comprises at least one alpha electrical pathway which extends between a first alpha pathway end to a second alpha pathway end; and
at least one second winding portion comprises at least one beta electrical pathway which extends between a first beta pathway end to a second beta pathway end, wherein:
the first and second winding portions are adapted to be electrically connected to form at least one coil wound around the toroidal core;
each coil is comprised of a plurality of pathway units; and
each pathway unit comprises an alpha electrical pathway connected to a beta electrical pathway, the second alpha pathway end is connected to the first beta pathway end, and the second beta pathway end is connected to the first alpha pathway end of the next pathway unit along the coil.

15. A kit according to claim 15, wherein each first winding portion comprises at least one body element, and at least one body element comprises one of a through-hole circuit board, a surface mount circuit board, or an insulated metal substrate surface mount circuit board.
